(19) United States
(12) Patent Application Publication
(10) Pub. No.: US 2006/0246403 A1
(43) Pub. Date: Nov. 2, 2006

(54) Electronic educational game set having communicating elements with a radio-frequency tag

(76) Inventors: Pascal Monpouet, Saint Etienne de Crossey (FR); Francois-Gilles Ricard, Saint Baldoph (FR); Anne-Marie Trannoy, Saint Martin d'Hères (FR)

Correspondence Address: OLIFF & BERRIDGE, PLC, P.O. BOX 19928, ALEXANDRIA, VA, 22320, US

(21) Appl. No.: 10/574,465

(22) PCT Filed: Oct. 19, 2004
(86) PCT No.: PCT/FR04/02663

§ 371 Date: Mar. 31, 2006

(30) Foreign Application Priority Data
Oct. 20, 2003 (FR) 0312249

(51) Int. Cl. G09B 19/22

(52) U.S. Cl. 434/128

(57) ABSTRACT

The invention relates to a game set which comprises communicating elements, in the form of pieces, figurines, cards or dice, each having a radio-frequency tag provided with an individual identification code. A game board comprises a digital processing circuit which is connected to a plurality of antennas, arranged such as to form a sensor matrix, for detecting the presence, type and position of the communicating elements. Radio-frequency readers are respectively connected to m corresponding input/output terminals of the digital processing circuit. Each radio-frequency reader is connected to an associated group of antennas, preferably by means of a corresponding multiplexer. The game board may consist of a removable assembly of basic boards, each comprising a basic digital processing circuit which is connected to the antennas of the corresponding basic board.

### BACKGROUND OF THE INVENTION

The invention relates to an electronic educational game set comprising communicating elements, each having a radio-frequency tag provided with an individual identification code, and a game board comprising a digital processing circuit connected to a plurality of antennas arranged such as to form a sensor matrix for detecting the presence, type and position of the communicating elements.

### STATE OF THE ART

In most electronic games, a player is installed in front of a console or a computer, man-machine communication being performed by means of a keyboard, a mouse, a joystick or a touch-sensitive screen. He may be able to play connected via a network with other players having their own computers and connected to the same communication network, for example via Internet.

Moreover, the document WO-A-9526790 proposes a combination of a game board and pieces equipped with a transponder, communicating by radio-frequency with the board and associated with an identification code. The document WO-A-0211836 also uses this principle for an electronic chess game, enabling the position of the different pieces to be displayed in real time on a display unit and, possibly, enabling these images to be transmitted via Internet. However, the particular components used in the chess game are costly and the detection field depth, about 20 mm, is too great and is liable to cause erroneous intermediate recognitions of pieces when the board is simply passed over. In addition, all known devices using radio-frequency communication between pieces and a game board are dedicated to a single type of game (chess) and have a relatively long response time, typically about 2.5 s.

### OBJECT OF THE INVENTION

It is an object of the invention to provide an educational game set not presenting these shortcomings and, more particularly, a set combining the user-friendliness of a conventional game and the advantages of an electronic game and having a lower response time.

According to the invention, this object is achieved by the accompanying claims and, more particularly, by the fact that the game board comprises a plurality of radio-frequency readers respectively connected to corresponding input/output terminals of the digital processing circuit, each radio-frequency reader being connected to an associated group of antennas.

The communicating elements can be formed by pieces, figurines, cards or dice.

It is a further object of the invention to provide an educational game set able to be easily adapted to different types of game. This object is achieved by the fact that the board is formed by a removable assembly of a plurality of basic boards, each comprising a basic digital processing circuit connected to the antennas of said basic board.

According to a development of the invention, the set comprises a removable game mat arranged on the game board and comprising a radio-frequency tag equipped with an identification code representative of the corresponding game.

### BRIEF DESCRIPTION OF THE DRAWINGS

Other advantages and features will become more clearly apparent from the following description of particular embodiments of the invention given as non-restrictive examples only and represented in the accompanying drawings, in which:

FIG. 1 schematically illustrates a particular embodiment of a set according to the invention.

FIG. 2 schematically represents a radio-frequency tag integrated in a communicating element of a set according to the invention.

FIG. 3 illustrates division, into lines and columns, of a game board of a set according to the invention.

FIGS. 4 and 5 illustrate two alternative embodiments of electric connections of a game board of a set according to the invention.

FIG. 6 represents a game board formed by assembly of several basic boards.

### DESCRIPTION OF PARTICULAR EMBODIMENTS

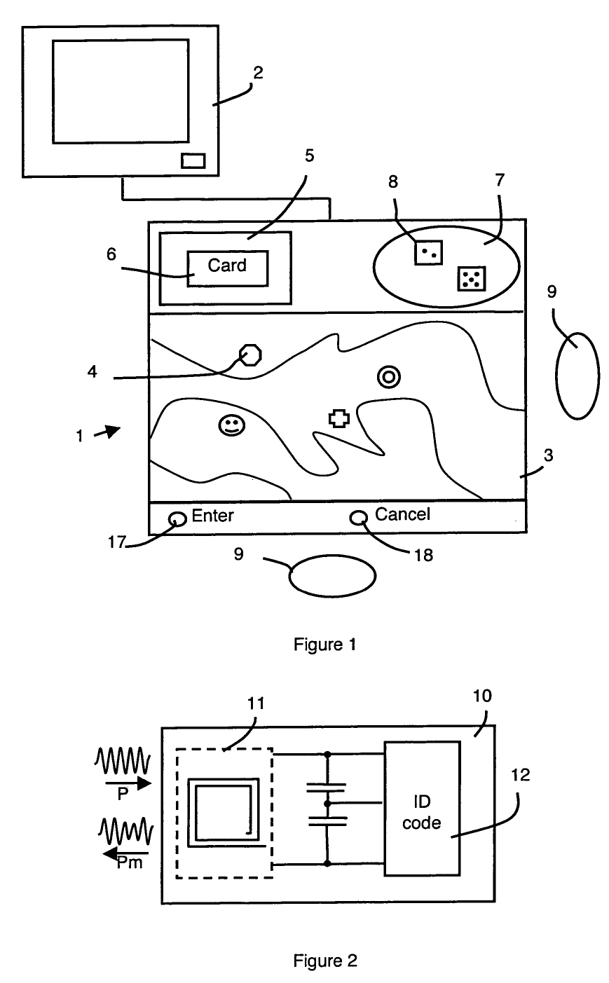

In the particular embodiment illustrated in FIG. 1, the educational game set comprises a game board 1 designed to cooperate, with or without wiring, preferably via a HF (hyper-frequency) link, with a computer 2, constituting an external display and supervision means. A preferably flexible and removable game mat 3 covers the board 1. The fact that the game mat is interchangeable makes it possible to switch easily from one game to another.

The board 1 comprises at least one game zone. In the embodiment represented in FIG. 1, a first game zone is designed for movement of different items 4, constituted by pieces or figurines. A second game zone forms a card tray 5 for reading a card 6, whereas a third game zone 7 delineates a space for throwing at least one dice 8.

Players 9 place themselves around the game board, equipped with the game mat corresponding to the selected game. The pieces or figurines 4, cards 6 and dice 8 constitute communicating elements whose presence, type and position are automatically detected by the game board. Each communicating element in fact comprises a radio frequency identification (RFID) tag 10, or radio-frequency tag, provided with an individual identification code (ID code) and the board comprises appropriate sensor elements arranged at predetermined locations of the board. The game mat 3 can also comprise a radio-frequency tag 10, thus enabling the selected game to be automatically identified by the game board 1 and computer 2.

As represented in FIG. 2, each tag 10 is, in known manner, formed by a passive radio-frequency tag, comprising an antenna 11 tuned to a pre-determined frequency and connected to a circuit 12 storing the corresponding individual identification code. A carrier signal P received by the tag 10 acts both as communication signal and power supply for the tag. The tag modifies the carrier signal, modulating it in amplitude (Pm) by its individual identification code. In a preferred embodiment, the tags 10 are extra-flat, with preferably rectangular antennas 11 formed by several turns of conducting tracks and connected to a circuit 12. The size of the tags can thus be reduced to a minimum, the tags being for example in the form of an extra-flat square with sides of about 2 cm, and they can thus be easily inserted in the pieces, figurines, cards, dice or the game mat.

The dice 8 can be a dice of conventional appearance comprising a tag 10 associated with each of its faces, i.e. 6 tags provided with 6 different identification codes respectively corresponding to the different numbers. At least one corresponding sensor element of the game board, arranged in a third game zone 7, delineating the place where the dice are thrown, then detects which face is in contact with the game board and, consequently, which number is visible. In an alternative embodiment, the dice 8 is “blank”, i.e. it does not bear any inscription representative of a number on each of its faces and only has one or two radio-frequency identification tags. In this case, when the presence of a dice is detected in the corresponding zone 7 of the game board 1, the computer 2 randomly selects a number and displays it on its screen. It is this number that is then used by the player concerned. Whether it be of conventional appearance or whether a blank be involved, the dice 8 can comprise a number of faces different from 6, typically 4, 6, 8, 10, 12 or 20 faces.

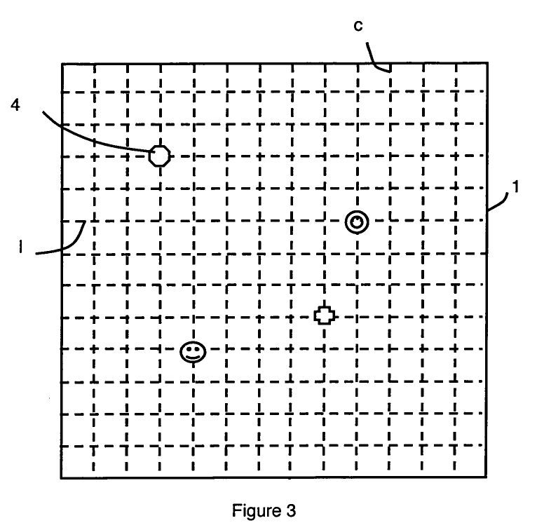

As represented by broken lines in FIG. 3, the game board 1 or, at least, the first game zone is divided into a plurality of locations delineated by lines I and columns c. A sensor matrix is formed by antennas 14 located at the intersections of the lines I and columns c on which the communicating elements can be placed. Each antenna 14 is preferably flat and formed by rectangular spirals made of conducting material (metal or conducting ink) forming a large number of turns. The dimensions of the antenna preferably correspond to a location of the game board having sides smaller than 2 cm, typically 18 mm.

To enable radio-frequency interrogation and reading of the communicating elements (for example pieces, figurines, cards, dice or game mat) arranged on the game board and thereby to detect the presence, type and position of these different communicating elements, the game board comprises a digital processing circuit 15, for example in the form of a printed circuit, connected to the antennas 14 by radio-frequency readers 13.

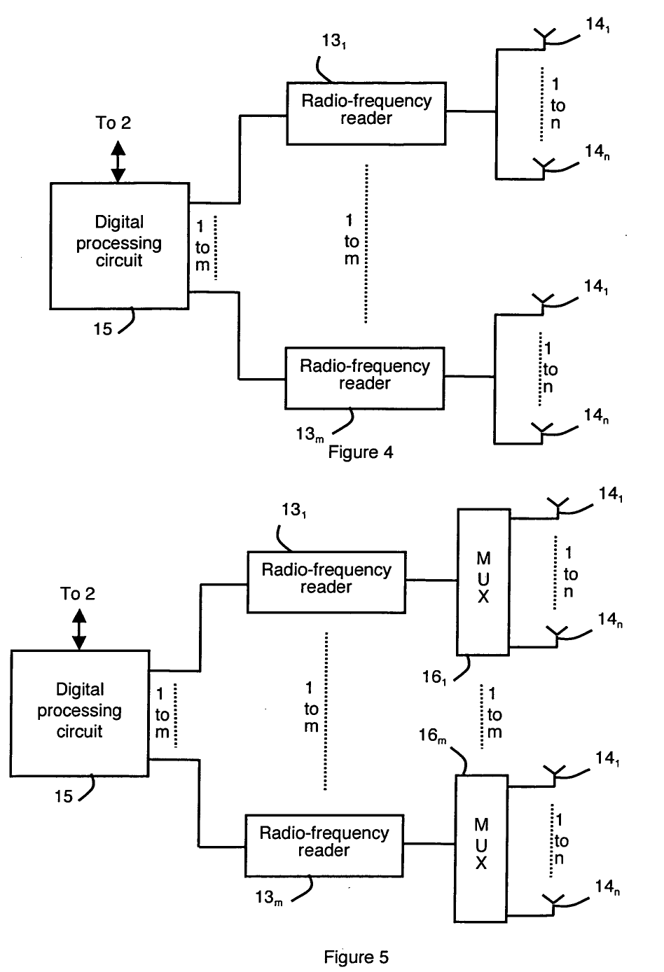

As represented in FIG. 4, the digital processing circuit 15 comprises a predetermined number m of input/output terminals, respectively connected to m radio-frequency readers (13₁ to 13ₘ). Each radio-frequency reader 13 is connected to a group of n antennas 14₁ to 14ₙ. In this particular embodiment, collisions have to be managed. Each radio-frequency reader 13 and each tag 10 of the communicating elements then have to integrate an anti-collision function, in known manner.

In the preferred embodiment of FIG. 5, a multiplexer 16 is arranged between each radio-frequency reader 13 and the associated group of n antennas. The radio-frequency readers 13 and tag 10 no longer have to manage possible collisions and can therefore be simplified. Each multiplexer 16 in fact enables selective interrogation and reading of each associated antenna under the control of the digital processing circuit 15.

For example, the board 1 can comprise 16 to 25 radio-frequency readers 13 each connected to 4, 8 or 16 antennas. Thus, with n=16 and m=16 or 25, it is respectively possible to form a matrix of nm=256 or 400 antennas.

Each sensor element 13 continuously checks whether a communicating element is present on the associated antennas 14₁ to 14ₙ. In known manner, a radio-frequency reader 13 continuously generates a substantially sinusoidal carrier signal P of predetermined frequency corresponding to the tuning frequency of the tags 10. If there is a communicating element present at the corresponding location, it modulates the carrier signal and the modulated carrier signal Pm is detected, demodulated and shaped by the radio-frequency reader.

At the request of the digital processing circuit 15, each radio-frequency reader 13 sends the information representative of the type (ID code) of the detected tag in frame form. If there is no communicating element at the location corresponding to an antenna 14, the associated radio-frequency reader remains mute. Thus, each radio-frequency reader 13 only communicates with the digital processing circuit 15 in the presence of a communicating element at a location of the game board corresponding to one of the associated antennas. The digital processing circuit 15, having recorded the position of each antenna, is therefore able to determine the position of the detected tag 10. The digital processing circuit 15 therefore continuously receives the data necessary for identification and positioning of all the pieces or figurines disposed on the board and can rapidly identify any change.

The carrier signal frequency is preferably about 14 MHz, typically 13.56 MHz. The field depth enabling detection of a tag can then be relatively small, typically about 5 mm. This enables detection errors when a piece or a figurine passes over the board to be eliminated and prevents interferences from being created between neighbouring locations. The use of other, lower, carrier frequencies, for example around 125 kHz, conventionally used in a certain number of applications using inexpensive radio-frequency tags, can also be envisaged.

The association of a radio-frequency reader with several antennas (14₁ to 14ₙ) and the parallel connection of several radio-frequency readers (13₁ to 13ₘ) on output of the digital processing circuit 15 enable the response time to be significantly reduced. For example, for a game board according to the invention comprising 400 locations, the response time, which would be about a few seconds, typically 2.5 s, if all the antennas of the sensor elements were connected to a serial input of a centralized processing circuit, is reduced to about 90 ms.

The tags 10 of the communicating elements are preferably solicited by the radio-frequency readers 13 during a read phase only. It is however possible to use tags 10 that are also able to be solicited during a write phase, so as to enable the identification code and/or the embedded history of the corresponding piece or figurine to be modified. The history associated with a communicating element is then stored in a memory of the tag 10 of this communicating element.

In an alternative embodiment, it is possible to disable a tag 10 so as to neutralize the corresponding communicating element. For example, this can be used in a role-playing game if a character associated with a figurine loses his life.

The combination of the game board 1 and computer 2, communicating with the digital processing circuit 15, enable the game to be managed by the computer 2 while providing the user-friendliness of the game board and the possibility of changing from one game to another easily. The same game board 1 can be used for any type of game using pieces, figurines, cards and/or dice, and more particularly for interactive digital games, parlour games, betting games and role-playing games. It can also be used in the educative or cultural field, in particular in tutorial, scenographic or museographic applications. For example, it can be used in the form of a game of goose enabling information constituted by animations on the computer screen 2 to be discovered as a piece is moved on the game board.

Game software relating to various different games having been previously loaded into the computer 2, a particular game can be chosen simply by placing the corresponding game mat 3 on the game board. If the game mat is provided with an identification tag 10, the computer 2 automatically identifies the selected game, if necessary after activation of a start button (not represented) located on the game board. The computer can then display the rules of the game and, in the course of the game, information concerning the game, indications to the players concerning the actions to be performed, video images, sound and/or computer-generated images (for example images of a hotel being built for a Monopoly® game), designed to illustrate or enrich the game. It can play the role of banker (for example in a Monopoly® type game), of referee. The computer 2 may be connected to the Internet. It is then possible to play against a remotely located opponent or team or to download video animations from the Internet. In a role-playing game, the computer 2 can play the role of game master. It can search on the Internet for information concerning the particular powers associated with a particular piece and display this information on its screen, preferably in ludic form.

Each communicating element is preferably associated with a unique individual identification code (ID) previously recorded in a data base. The set comprises, in the digital processing circuit 15 or preferably in the computer 2, in the memory of the tags 10 and/or in an external data base accessible on-line in Internet, means for storing the historical account of the movements and/or rights of the different communicating elements in the course of the game or throughout the life of a communicating element, the rights of a figurine being able to change from one game to another. For role-playing games in particular, this historical account may include the evolution in time of the characteristics, qualities or qualification of a figurine, for example going from childhood to adulthood, acquisition or loss of certain powers.

The game board 1 can comprise one or more enter buttons 17 (for example four) and a cancel button 18 (FIG. 1) connected to the digital processing circuit 15. An enter button 17 is designed, in certain games, to validate the move that has just been made. In games in which the enter buttons are not used, the move is considered as being played as soon as an item (piece or figurine) is placed on the game board. Depending on the type of game, the computer 2 can indicate to the players, at the beginning or in the course of the game, whether the enter buttons have to be used. The cancel button 18 is designed to be able to revert to the previous position of the pieces on the game board. This can be interesting in particular if the items are accidentally upset on the game board. The computer screen then displays the former position of the different pieces on the game board so that the players can reset the game to its previous state.

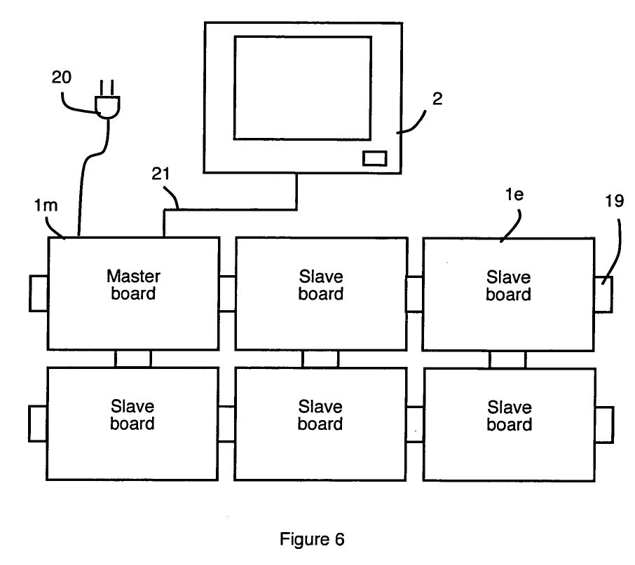

As represented in FIG. 6, a game board can be constituted by a removable assembly of several basic boards so as to modulate or enlarge the playing surface according to requirements. Each basic board comprises a basic digital processing circuit 15 connected to the antennas 14 of this basic board. This removable assembly is more particularly interesting in role-playing games. The set represented comprises 6 basic boards each equipped, on three of the lateral sides thereof, with assembling connectors 19 enabling any basic board to be electrically and mechanically connected to one, two or three other adjacent basic boards. Electrically, connection between the digital processing circuits 15 of two basic boards is preferably performed without wires or by a serial connection, which is reliable and saves space.

The set can comprise a main board initially configured as the master board 1m and several additional boards initially configured as slave boards 1e.

In a particular embodiment integrating physical connections, all the basic boards are initially identical, but only one of the basic boards constituting the master board 1m is connected, via the fourth lateral side thereof, to an electric power supply by means of a power supply connector 20, and to the computer 2, possibly by means of a hard-wired connection 21. All the other basic boards then constitute the slave boards 1e connected to the master board 1m either directly or via other slave boards 1e. Each assembly connector 19 therefore has to enable two-way data transmission between two adjacent basic boards, for example by means of an output wire and an input wire. It must also enable power supply of the basic board from the power supply connector 20 of the master board 1m, for example by means of two power supply wires, one of which is grounded.

Configuration of a basic board as master board 1m or slave board 1e can be performed automatically, preferably when the game board constituted by the set of basic boards is powered on, under the control of the computer 2 which comprises, for example, means for recognizing the arrangement of the boards.

In a preferred embodiment, the board 1 is formed by a plurality of basic boards and the basic digital processing circuits 15 all communicate without wires, between one another and/or directly with the external display and supervision means 2.

The invention is not limited to the particular embodiments described above. In particular, recognition of a card 6 placed in the card tray 5 may be performed by optic detection. In this case, the cards 6 do not comprise a radio-frequency tag but optic identifying elements encoded in the form of black and white dots or of a barcode for example, able to be identified by suitable detectors arranged in the second game zone and connected to the digital processing circuit 15.

Moreover, in preferential manner, the game board may comprise a single game zone enabling the presence, type and position of any type of communicating element (piece, figurine, dice, card or game mat) to be detected.

The assembly can also comprise a screen, for example a liquid crystal display, enabling the game mat 3 to be displayed in virtual, dematerialized form on a front face of the game board 1, i.e. on the top surface thereof. This screen may display windows designed to act as interface for the display and supervision means 2. The game board can then integrate the supervision means totally. In the latter case, the educational game set can become completely autonomous.

The game board 1 can also manage broadcasting of sound files complementary to those broadcast by the supervision means 2. These complementary sound files can be recorded in a library embedded in a dedicated memory module and/or the HF link can be used to retransmit the sounds of the applications from the board.

1-21. (canceled)

22. Electronic educational game set comprising communicating elements, each having a radio-frequency tag provided with an individual identification code, and a game board comprising a digital processing circuit connected to a plurality of antennas arranged such as to form a sensor matrix for detecting the presence, type and position of the communicating elements, wherein the game board comprises a plurality of radio-frequency readers respectively connected to corresponding input/output terminals of the digital processing circuit, each radio-frequency reader being connected to an associated group of antennas.

23. Set according to claim 22, comprising a multiplexer between each radio-frequency reader and the associated group of antennas.

24. Set according to claim 22, wherein the board is formed by a removable assembly of a plurality of basic boards each comprising a basic digital processing circuit connected to the antennas of said basic board.

25. Set according to claim 24, wherein each basic board comprises, on three lateral sides thereof, means for electrical and mechanical connection with another basic board.

26. Set according to claim 24, wherein each basic board comprises means for configuring as master board or slave board, only the master board communicating with a display and supervision means.

27. Set according to claim 24, wherein the basic digital processing circuits of the basic boards communicate without wires between one another and/or with an external display and supervision.

28. Set according to claim 22, wherein the communicating elements comprise pieces, figurines, cards or dice.

29. Set according to claim 22, wherein the game board comprises several game zones respectively dedicated to different types of communicating elements.

30. Set according to claim 22, wherein the communicating elements comprise at least one dice, the game board comprising at least one corresponding sensor element arranged in a game zone delineating a space for throwing dice.

31. Set according to claim 30, wherein the dice comprises a radio-frequency tag associated with each of its faces, the different tags of the dice being provided with different identification codes.

32. Set according to claim 30, wherein the dice comprises at least one radio-frequency identification tag, the set comprising selection means for randomly selecting a number and for displaying the selected number on a screen, when the presence of the dice is detected.

33. Set according to claim 22, comprising a removable game mat arranged on the game board and comprising a radio-frequency tag provided with an identification code representative of the corresponding game.

34. Set according to claim 22, comprising a screen enabling a virtual game mat to be displayed on a front face of the game board.

35. Set according to claim 22, wherein the radio-frequency readers emit carrier signals having a frequency of about 14 MHz.

36. Set according to claim 22, wherein the radio-frequency readers emit carrier signals having a frequency of about 125 kHz.

37. Set according to claim 22, wherein each individual code being unique, the set comprises means for storing the historical account of the characteristics and/or of the movements of the communicating elements on the game board.

38. Set according to claim 37, wherein the means for storing comprise an external data base accessible via Internet.

39. Set according to claim 37, wherein the means for storing comprise means for storing the historical account associated with a communicating element in a memory of the tag of said communicating element.

40. Set according to claim 22, wherein the game board comprises at least one enter button connected to the digital processing circuit.

41. Set according to claim 22, wherein the game board comprises a cancel button connected to the digital processing circuit.

42. Electronic set comprising communicating elements, each having a radio-frequency tag provided with an individual identification code, and a board comprising a digital processing circuit connected to a plurality of antennas arranged such as to form a sensor matrix for detecting the presence, type and position of the communicating elements, wherein the board comprises a plurality of radio-frequency readers respectively connected to corresponding input/output terminals of the digital processing circuit, each radio-frequency reader being connected to an associated group of antennas.
